(19) United States
(12) Patent Application Publication
(10) Pub. No.: US 2024/0345215 A1
(43) Pub. Date: Oct. 17, 2024

(54) SENSOR CALIBRATION

(71) Applicant: Ford Global Technologies, LLC, Dearborn, MI (US)

(72) Inventor: Kunle Olutomilayo, Newark, CA (US)

(73) Assignee: Ford Global Technologies, LLC, Dearborn, MI (US)

(21) Appl. No.: 18/300,479

(22) Filed: Apr. 14, 2023

(51) Int. Cl. G01S 7/40; G01S 13/931; G06T 7/80

(52) U.S. Cl. CPC G01S 7/40; G01S 13/931; G06T 7/80; G06T 2207/30242; G06T 2207/30252

(57) ABSTRACT

A computer is programmed to receive first sensor data from a sensor of a vehicle indicating a first relative position of a stationary object, the first relative position detected while the vehicle is in a first vehicle pose; receive second sensor data from the sensor indicating a second relative position of the stationary object, the second relative position detected while the vehicle is in a second vehicle pose having a different orientation than the first vehicle pose; and determine one of a calibration parameter or a vehicle relative pose based on the first relative position, the second relative position, and the other of the calibration parameter or the vehicle relative pose. The calibration parameter defines a sensor pose of the sensor relative to the vehicle. The vehicle relative pose defines a transformation of the vehicle from the first vehicle pose to the second vehicle pose.

### BACKGROUND

Modern vehicles typically include a variety of sensors. The sensors often include sensors that detect the external world, e.g., objects and/or characteristics of surroundings of the vehicle, such as other vehicles, road lane markings, traffic lights and/or signs, pedestrians, etc. Examples of such sensors include radar sensors, ultrasonic sensors, scanning laser range finders, light detection and ranging (lidar) devices, and image processing sensors such as cameras.

### BRIEF DESCRIPTION OF THE DRAWINGS

FIG. 1 is a block diagram of an example vehicle.

FIG. 2 is a diagram of example movement of the vehicle relative to an object.

FIG. 3 is a flowchart of an example process for determining a calibration parameter or vehicle pose for the vehicle.

### DETAILED DESCRIPTION

This disclosure describes techniques to calibrate a sensor on board a vehicle based on a change in pose of the vehicle and to determine the change in pose of the vehicle using data from the calibrated sensor. A computer of the vehicle is programmed to receive sensor data indicating relative positions of a stationary object while the vehicle is in respective poses with different orientations, and to determine one of a calibration parameter or a vehicle relative pose based on the relative positions of the stationary object and based on the other of the calibration parameter or the vehicle relative pose. The calibration parameter defines a sensor pose of the sensor relative to the vehicle, and the vehicle relative pose defines a transformation of the vehicle between two of the vehicle poses. By taking advantage of the change in pose by the vehicle, the computer is able to calibrate the sensor using an arbitrary object in the environment rather than a specific target designed for calibrating sensors, meaning that the calibration may take place during regular use of the vehicle. Moreover, the change in pose of the vehicle is between poses with different orientations, so the vehicle does not need to travel in a straight line or remain stationary as required by some calibration techniques. The computer may use the vehicle relative pose or data from the calibrated sensor for actuating the vehicle, e.g., using one or more advanced driver assistance systems (ADAS).

A computer includes a processor and a memory, and the memory stores instructions executable by the processor to receive first sensor data from a sensor of a vehicle indicating a first relative position of a stationary object, the first relative position detected while the vehicle is in a first vehicle pose; receive second sensor data from the sensor indicating a second relative position of the stationary object, the second relative position detected while the vehicle is in a second vehicle pose having a different orientation than the first vehicle pose; and determine one of a calibration parameter or a vehicle relative pose based on the first relative position, the second relative position, and the other of the calibration parameter or the vehicle relative pose. The calibration parameter defines a sensor pose of the sensor relative to the vehicle, and the vehicle relative pose defines a transformation of the vehicle from the first vehicle pose to the second vehicle pose.

In an example, the instructions may further include instructions to actuate a component of the vehicle based on the one of the calibration parameter or the vehicle relative pose.

In an example, the instructions may further include instructions to determine the calibration parameter based on the first relative position of the stationary object, the second relative position of the stationary object, and the vehicle relative pose. In a further example, the instructions may further include instructions to determine the vehicle relative pose based on motion data of the vehicle. In a yet further example, the vehicle relative pose may include a vehicle translation and a vehicle rotation, and the motion data may define the vehicle translation and the vehicle rotation.

In another further example, the instructions may further include instructions to receive sensor data indicating a plurality of relative positions of the stationary object, the relative positions including the first relative position and the second relative position, the relative positions detected while the vehicle is in a plurality of vehicle poses including the first vehicle pose and the second vehicle pose; and determine a plurality of vehicle relative poses between pairs of the vehicle poses of the vehicle, the vehicle relative poses including the vehicle relative pose. In a yet further example, the instructions may further include instructions to determine the calibration parameter based on the relative positions of the stationary object and the vehicle relative poses.

In another yet further example, the pairs of the vehicle poses of the vehicle may include at least one pair in which the vehicle poses are nonconsecutive.

In another yet further example, at least one of the vehicle poses of the vehicle may be in at least two of the pairs.

In another yet further example, at least one of the vehicle poses of the vehicle may be in at least three of the pairs.

In another yet further example, the plurality of the vehicle poses of the vehicle may be nonlinear.

In another further example, the calibration parameter may include a sensor orientation of the sensor relative to the vehicle. In a yet further example, the vehicle relative pose may include a vehicle rotation, and the instructions may further include instructions to determine the sensor orientation based on the first relative position of the stationary object, the second relative position of the stationary object, and the vehicle rotation. In a still yet further example, the vehicle relative pose may include a vehicle translation, and the instructions to determine the sensor orientation may include instructions to determine the sensor orientation without the vehicle translation.

In another still yet further example, the calibration parameter includes a sensor position of the sensor relative to the vehicle, the vehicle relative pose includes a vehicle translation, and the instructions further include instructions to determine the sensor position based on the vehicle rotation and the vehicle translation.

In an example, the instructions may further include instructions to determine the vehicle relative pose based on the first relative position of the stationary object, the second relative position of the stationary object, and the calibration parameter. In a further example, the calibration parameter may include a sensor orientation of the sensor relative to the vehicle and a sensor position relative to the vehicle.

In an example, the vehicle relative pose may include a vehicle translation and a vehicle rotation.

In an example, the sensor may be one of a radar, a lidar, or a camera.

A method includes receiving first sensor data from a sensor of a vehicle indicating a first relative position of a stationary object, the first relative position detected while the vehicle is in a first vehicle pose; receiving second sensor data from the sensor indicating a second relative position of the stationary object, the second relative position detected while the vehicle is in a second vehicle pose having a different orientation than the first vehicle pose; and determining one of a calibration parameter or a vehicle relative pose based on the first relative position, the second relative position, and the other of the calibration parameter or the vehicle relative pose. The calibration parameter defines a sensor pose of the sensor relative to the vehicle, and the vehicle relative pose defines a transformation of the vehicle from the first vehicle pose to the second vehicle pose.

With reference to the Figures, wherein like numerals indicate like parts throughout the several views, a computer 105 includes a processor and a memory, and the memory stores instructions executable by the processor to receive first sensor data from a sensor 110 of a vehicle 100 indicating a first relative position 210a of a stationary object 205, the first relative position 210a detected while the vehicle 100 is in a first vehicle pose 215a; receive second sensor data from the sensor 110 indicating a second relative position 210b of the stationary object 205, the second relative position 210b detected while the vehicle 100 is in a second vehicle pose 215b having a different orientation than the first vehicle pose 215a; and determine one of a calibration parameter or a vehicle relative pose 220 based on the first relative position 210a, the second relative position 210b, and the other of the calibration parameter or the vehicle relative pose 220. The calibration parameter defines a sensor pose 225 of the sensor 110 relative to the vehicle 100. The vehicle relative pose 220 defines a transformation of the vehicle 100 from the first vehicle pose 215a to the second vehicle pose 215b.

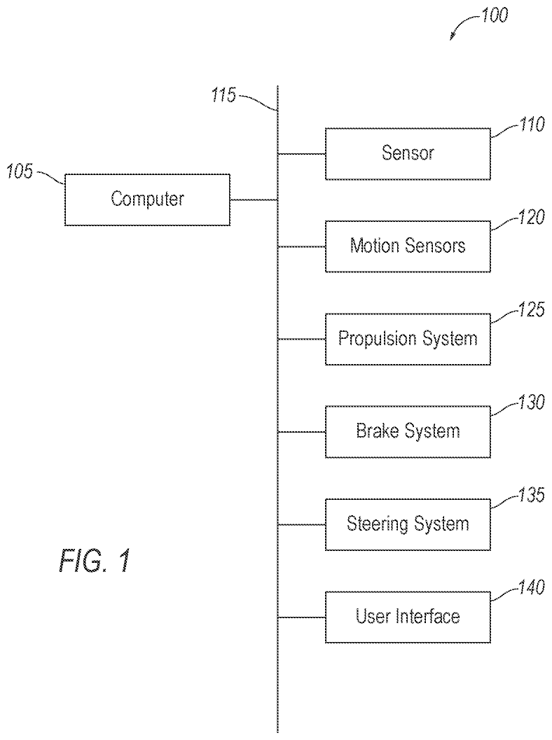

With reference to FIG. 1, the vehicle 100 may be any passenger or commercial automobile such as a car, a truck, a sport utility vehicle, a crossover, a van, a minivan, a taxi, a bus, etc. Alternatively, the vehicle 100 may be a flying vehicle such as an airplane, jet, drone, unmanned aerial vehicle (UAV), etc., or the vehicle 100 may be a watercraft such as a boat, submarine, unmanned underwater vehicle (UUV), unmanned surface vehicle (USV), etc.

The computer 105 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may transmit and receive data through a communications network 115 such as a controller area network (CAN) bus, Ethernet, WiFi, Local Interconnect Network (LIN), onboard diagnostics connector (OBD-II), and/or by any other wired or wireless communications network. The computer 105 may be communicatively coupled to the sensor 110, motion sensors 120, a propulsion system 125, a brake system 130, a steering system 135, a user interface 140, and other components via the communications network 115.

The sensor 110 detects the external world, e.g., objects and/or characteristics of surroundings of the vehicle 100, such as other vehicles, road lane markings, traffic lights and/or signs, pedestrians, etc. The sensor 110 is therefore an environmental sensor. For example, the sensor 110 may be a radar sensor, an ultrasonic sensor, a scanning laser range finder, a light detection and ranging (lidar) device, or an image processing sensor such as a camera. As a camera, the sensor 110 can detect electromagnetic radiation in some range of wavelengths. For example, the sensor 110 may detect visible light, infrared radiation, ultraviolet light, or some range of wavelengths including visible, infrared, and/or ultraviolet light. For example, the camera can be a charge-coupled device (CCD), complementary metal oxide semiconductor (CMOS), or any other suitable type. The techniques described below are usable when the sensor 110 is a camera even though the camera does not return depth data. As a radar, the sensor 110 transmits radio waves and receives reflections of those radio waves to detect physical objects in the environment. The sensor 110 can use direct propagation, i.e., measuring time delays between transmission and reception of radio waves, and/or indirect propagation, i.e., Frequency Modulated Continuous Wave (FMCW) method, i.e., measuring changes in frequency between transmitted and received radio waves. As a lidar, the sensor 110 detects distances to objects by emitting laser pulses at a particular wavelength and measuring the time of flight for the pulse to travel to the object and back. The sensor 110 can be any suitable type for providing the lidar data on which the computer 105 can act, e.g., spindle-type lidar, solid-state lidar, flash lidar, etc. The sensor 110 may be fixed to a body of the vehicle 100, e.g., rigidly mounted to the body of the vehicle 100.

The motion sensors 120 may detect the position and/or orientation of the vehicle 100. For example, the motion sensors 120 may include global navigation satellite system (GNSS) sensors such as global positioning system (GPS) sensors; accelerometers such as piezo-electric or microelectromechanical systems (MEMS); gyroscopes such as rate, ring laser, or fiber-optic gyroscopes; inertial measurements units (IMU); and/or magnetometers. The GPS sensor receives data from GPS satellites. The Global Positioning System (GPS) is a global navigation satellite system. The satellites broadcast time and geolocation data. The GPS sensor can determine a position of the vehicle 100, i.e., latitude and longitude, based on receiving the time and geolocation data from multiple satellites simultaneously.

The propulsion system 125 of the vehicle 100 generates energy and translates the energy into motion of the vehicle 100. The propulsion system 125 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion system 125 can include an electronic control unit (ECU) or the like that is in communication with and receives input from the computer 105 and/or a human operator. The human operator may control the propulsion system 125 via, e.g., an accelerator pedal and/or a gear-shift lever.

The brake system 130 is typically a conventional vehicle braking subsystem and resists the motion of the vehicle 100 to thereby slow and/or stop the vehicle 100. The brake system 130 may include friction brakes such as disc brakes, drum brakes, band brakes, etc.; regenerative brakes; any other suitable type of brakes; or a combination. The brake system 130 can include an electronic control unit (ECU) or the like that is in communication with and receives input from the computer 105 and/or a human operator. The human operator may control the brake system 130 via, e.g., a brake pedal.

The steering system 135 is typically a conventional vehicle steering subsystem and controls the turning of the wheels. The steering system 135 may be a rack-and-pinion system with electric power-assisted steering, a steer-by-wire system, as both are known, or any other suitable system. The steering system 135 can include an electronic control unit (ECU) or the like that is in communication with and receives input from the computer 105 and/or a human operator. The human operator may control the steering system 135 via, e.g., a steering wheel.

The user interface 140 presents information to and receives information from an operator of the vehicle 100. The user interface 140 may be located, e.g., on an instrument panel in a passenger cabin of the vehicle 100, or wherever may be readily seen by the operator. The user interface 140 may include dials, digital readouts, screens, speakers, and so on for providing information to the operator, e.g., human-machine interface (HMI) elements such as are known. The user interface 140 may include buttons, knobs, keypads, microphone, and so on for receiving information from the operator.

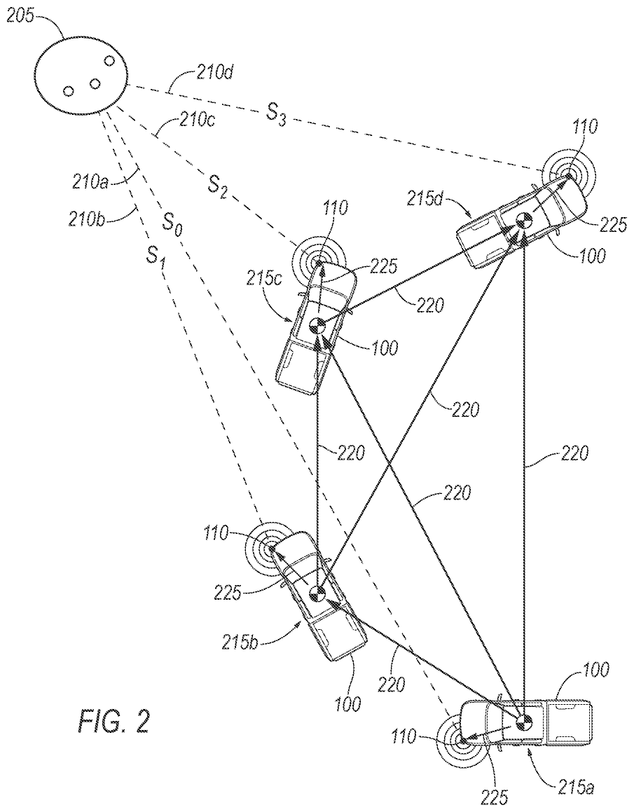

With reference to FIG. 2, the calibration parameter partly or completely defines a sensor pose 225 of the sensor 110 relative to the vehicle 100, i.e., relative to a reference frame defined by the vehicle 100. In other words, the sensor pose 225 may represent an extrinsic calibration of the sensor 110. The reference frame may, e.g., include an origin located at a center of a rear axle of the vehicle 100, an X-axis directed longitudinally forward, a Y-axis directed laterally leftward, and a Z-axis directed vertically upward, as specified in ISO standards. The sensor pose 225 may include a sensor orientation Q of the sensor 110 relative to the vehicle 100 and a sensor position d of the sensor 110 relative to the vehicle 100. The sensor orientation Q may include three angular degrees of freedom, e.g., specified as three angular coordinates about the X-, Y-, and Z-axes, or equivalently specified as a 3×3 rotation matrix. The sensor position d may include three spatial degrees of freedom along the X-, Y-, and Z-axes, e.g., specified as three coordinates in a 3×1 vector.

The vehicle 100 moves through a plurality of vehicle poses 215, e.g., in the example of FIG. 2, a first vehicle pose 215a, a second vehicle pose 215b, a third vehicle pose 215c, and a fourth vehicle pose 215d. Each vehicle pose 215 may include a position and orientation of the vehicle 100 relative to the environment, e.g., in six degrees of freedom. The vehicle poses 215 have different orientations, i.e., the vehicle 100 turns between at least one pair of consecutive vehicle poses 215. The vehicle poses 215 may be nonlinear, i.e., the vehicle 100 may travel along a curve passing through the vehicle poses 215. The techniques below can be used to calibrate the sensor 110 or use data from the sensor 110 to determine the vehicle relative pose 220 even with the vehicle 100 turning and traveling along a nonlinear path through the vehicle poses 215.

The techniques below use at least one vehicle relative pose 220, e.g., a plurality of vehicle relative poses 220. Each vehicle relative pose 220 defines a transformation of the vehicle 100 from one of the vehicle poses 215 to a different one of the vehicle poses 215, i.e., between a pair of the vehicle poses 215. For example, each vehicle relative pose 220 may include a vehicle translation and a vehicle rotation. The vehicle translation may be specified in two or three spatial coordinates. The vehicle rotation may be specified in at least one angular coordinate, e.g., three angular coordinates, or equivalently a 3×3 rotation matrix. The pairs of the vehicle poses 215 used for the vehicle relative poses 220 may include consecutive pairs and/or nonconsecutive pairs. For example, all the pairs may be used, as shown in the example FIG. 2. The number of pairs is up to the number of combinations of two vehicle poses 215 drawn from the total number of vehicle poses 215, i.e., _{I}C₂=I![2(I−2)!], in which I is the total number of vehicle poses 215. For four vehicle poses 215 as in the example of FIG. 2, the number of pairs may be up to six. The vehicle poses 215 may be drawn from multiple trips of the vehicle 100 or multiple separate environments through which the vehicle 100 travels, in which case the pairs of the poses are formed within and not across the multiple trips or environments. Each vehicle pose 215 may be used in multiple pairs, e.g., at least two pairs or at least three pairs, in which case nonconsecutive pairs are necessarily included.

The computer 105 is programmed to receive motion data indicating motion of the vehicle 100 while traveling through the vehicle poses 215. The motion sensors 120 may produce the motion data. The motion data may define the vehicle relative pose 220, e.g., the vehicle translation t_{i,j} and the vehicle rotation R_{i,j}, between any time steps i and j. For example, IMUs of the motion sensors 120 may indicate the vehicle translation and the vehicle rotation.

The computer 105 is programmed to receive sensor data from the sensor 110. The sensor 110 is moving while generating the sensor data, e.g., resulting from movement of the vehicle 100 through the vehicle poses 215. For example, if the sensor 110 is a camera, the sensor data are a sequence of image frames of the field of view of the sensor 110. Each image frame is a two-dimensional matrix of pixels. Each pixel has a brightness or color represented as one or more numerical values, e.g., a scalar unitless value of photometric light intensity between 0 (black) and 1 (white), or values for each of red, green, and blue, e.g., each on an 8-bit scale (0 to 255) or a 12- or 16-bit scale. The pixels may be a mix of representations, e.g., a repeating pattern of scalar values of intensity for three pixels and a fourth pixel with three numerical color values, or some other pattern. Location in an image frame can be specified in pixel dimensions or coordinates, e.g., an ordered pair of pixel distances, such as a number of pixels from a top edge and a number of pixels from a left edge of the image frame. For another example, if the sensor 110 is a radar or a lidar, the sensor data is a point cloud. The point cloud includes a plurality of points defined by a direction and distance from the sensor 110, e.g., in polar coordinates in a reference frame of the sensor 110.

The scene viewed by the sensor 110 includes at least one object 205, e.g., a plurality of objects 205. While the description below refers to a single object 205, the techniques may be performed using multiple objects, e.g., from different scenes if the vehicle poses 215 are drawn from multiple trips of the vehicle 100 or from the same scene during the same trip of the vehicle 100. The object 205 is stationary. The computer 105 may be programmed to determine that the object 205 is stationary. For example, the computer 105 can identify the object 205 using conventional image-recognition techniques, e.g., a convolutional neural network programmed to accept images as input and output an identified object, as a type of object that is classified as stationary. A convolutional neural network includes a series of layers, with each layer using the previous layer as input. Each layer contains a plurality of neurons that receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates a score for each potential type of object, and the final output is the type with the highest score. The memory of the computer 105 may store classifications of the types as stationary or nonstationary, e.g., road signs as stationary and bicycles as nonstationary, e.g., as a lookup table.

The sensor data indicates a plurality of relative positions 210 Sᵢ of the object 205, the relative positions 210 detected while the vehicle 100 is in the vehicle poses 215, i.e., at the time steps i. In the example of FIG. 2, the sensor data indicates four relative positions 210 Sᵢ, a first relative position 210a S₀, a second relative position 210b Sᵢ, a third relative position 210c S₂, and a fourth relative position 210d S₃. Each relative position 210 Sᵢ partially or fully defines the position of the object 205 relative to the vehicle 100 at the respective time step i. For example, the pixel coordinate of the object 205 in an image frame defines a direction from the vehicle 100 to the object 205, thereby partially defining the position of the object 205 relative to the vehicle 100. For another example, the coordinates of a point in the point cloud define a direction and distance from the vehicle 100 to the object 205, thereby fully defining the position of the object 205 relative to the vehicle 100.

The relative positions 210 of the object 205 at two timesteps i, j are related via a geometric relationship according to the calibration parameter and the vehicle relative pose 220, as in the following equation:

$${QS}_{j} + d {1}^{T} = {R}_{i , j} {QS}_{i} + {R}_{i , j} d {1}^{T} + {t}_{i , j} {1}^{T}$$

in which Q is the sensor orientation, Sᵢ is the relative position 210 of the object 205 relative to the sensor 110 at timestep i, d is the sensor position, R_{i,j} is the vehicle rotation from timestep i to timestep j, t_{i,j} is the vehicle translation from timestep i to timestep j, and 1^{T} is a row vector with entries equal to 1.

The computer 105 is programmed to determine one of the calibration parameter or the vehicle relative pose 220 based on at least two relative positions 210 of the object 205 and based on the other of the calibration parameter or the vehicle relative pose 220. For example, the computer 105 may receive an instruction specifying which of the calibration parameter or the vehicle relative pose 220 to determine. For example, the computer 105 may determine the calibration parameter, i.e., to calibrate the sensor 110, at a predefined time, e.g., upon starting the vehicle 100 or every 100 miles. For example, the computer 105 may determine the vehicle relative pose 220 as the vehicle 100 travels, i.e., at each timestep.

The computer 105 may be programmed to determine the calibration parameter based on the relative positions 210 of the stationary object 205 and the vehicle relative poses 220. As an overview, the computer 105 determines the vehicle relative poses 220 between the pairs of the vehicle poses 215 based on the motion data as described above, determines a cumulative rotation and cumulative translation for each vehicle relative pose 220, determines the sensor orientation without the vehicle translation based on the cumulative rotation and the vehicle relative poses 220, and determines the sensor position based on the vehicle rotation and the vehicle translation.

The computer 105 may be programmed to determine the cumulative rotation U_{i,j} from timestep i to timestep j, and the cumulative translation τ_{i,j} from timestep i to timestep j, for each pair of vehicle relative poses 220. The cumulative rotation U_{i,j} is defined to be U_{i,j}=Q^{T}R_{i,j}Q. The cumulative translation τ_{i,j} is defined to be τ_{i,j}=Q^{T}(R_{i,j}d−d+t_{i,j}). The geometric relationship described above is therefore equivalent to this equation:

$${S}_{j} = {U}_{i , j} {S}_{i} + {τ}_{i , j} {1}^{T}$$

The cumulative rotation U_{i,j} and the cumulative translation τ_{i,j} may be determined by solving the foregoing equation, e.g., with some optimization algorithm. For example, the geometric relationship may be transformed into the following form, and the computer 105 may execute a Kabsch algorithm to determine the cumulative rotation U_{i,j} and the cumulative translation τ_{i,j} that minimize the deviation from the geometric relationship:

$${min}_{{U}_{i , j} , {τ}_{i , j}} {‖ {U}_{i , j} {S}_{i} - {S}_{j} + {τ}_{i , j} {1}^{T} ‖}_{F}^{2}$$

in which ∥⋅∥_{F} denotes the Frobenius norm of a matrix. The computer 105 may solve the geometric relationship, e.g., execute the Kabsch algorithm, for each pair i, j of the timesteps i, j that will be used for the solution, as described above.

The computer 105 is programmed to determine the sensor orientation Q. The computer 105 determines the sensor orientation Q without the cumulative translation τ_{i,j}, and thereby without the vehicle translation τ_{i,j}. The computer 105 determines the sensor orientation Q based on the cumulative rotations U_{i,j} and the vehicle rotations R_{i,j}. The cumulative rotations U_{i,j} may be vectorized in order to be collected in a single matrix Uₐₗₗ, as in the following expression:

$$vec ( {U}_{i , j} ) = ( {Q}^{T} ⊗ {Q}^{T} ) vec ( {R}_{i , j} )$$

in which vec( ) is function returning a vector arrangement of a matrix, ⊗ is the Kronecker product, and the superscript T is the transpose. The vectorization function vec( ) returns a column vector containing each column of the argument matrix arranged in order, so a 3×3 matrix becomes a 9×1 vector. The collected cumulative rotations Uₐₗₗ may be defined by the following expression:

$${U}_{all} = [ \begin{matrix}vec ( {U}_{0 , 1} ) & vec ( {U}_{0 , 2} ) & … & vec ( {U}_{N - 1 , N} )\end{matrix} ]$$

in which N is the total number of pairs of vehicle poses 215 to be used. The collected cumulative rotations Uₐₗₗ are a 9×N matrix. The vehicle rotations R_{i,j} may also be vectorized and collected in a single matrix Rₐₗₗ:

$${R}_{all} = [ \begin{matrix}vec ( {R}_{0 , 1} ) & vec ( {R}_{0 , 2} ) & … & vec ( {R}_{N - 1 , N} )\end{matrix} ]$$

The collected cumulative rotations Uₐₗₗ and the vehicle rotations Rₐₗₗ are related as follows:

$${U}_{all} = ( {Q}^{T} ⊗ {Q}^{T} ) {R}_{all}$$

This formulation can be solved for the sensor orientation Q. For example, an optimization algorithm may be used to determine the sensor orientation Q that minimizes a deviation from that formulation, as in the following expression. The sensor orientation Q may be parameterized into pitch θ, yaw ϕ, and roll ψ components to facilitate the optimization algorithm.

$${min}_{θ , ϕ , ψ} {‖ {U}_{all} - ( {Q}_{( θ , ϕ , ψ )}^{T} ⊗ {Q}_{( θ , ϕ , ψ )}^{T} ) {R}_{all} ‖}_{F}^{2}$$

The computer 105 may be programmed to determine the sensor position d based on the vehicle rotation R_{i,j}, the vehicle translation τ_{i,j}, and the sensor orientation Q. The computer 105 determines the sensor position d after determining the sensor orientation Q. The definition of the cumulative translation τ_{i,j} above transforms into the following form:

$${R}_{i , j} d - d + {t}_{i , j} - Q {τ}_{i , j} = 0$$

The left side of this equation may be treated as a function ƒ_{i,j} of d that can be collected into a matrix F that is then minimized for d, since the function ƒ_{i,j} equals zero:

$$F ( d ) = [ \begin{matrix}{f}_{0 , 1} ( d ) & {f}_{0 , 2} ( d ) & … & {f}_{N - 1 , N} ( d )\end{matrix} ] \\ {min}_{d} {‖ F ( d ) ‖}_{F}^{2}$$

With the sensor position d and the sensor orientation Q, i.e., the calibration parameter, the computer 105 may process data received from the sensor 110.

The computer 105 may be programmed to actuate a component of the vehicle 100 based on the calibration parameter. The component may include, e.g., the propulsion system 125, the brake system 130, the steering system 135, and/or the user interface 140. For example, the computer 105 may actuate the component in executing an advanced driver assistance system (ADAS). ADAS are electronic technologies that assist drivers in driving and parking functions. Examples of ADAS include forward collision detection, lane-departure detection, blind-spot detection, automatic braking, adaptive cruise control, and lane-keeping assistance. For example, the computer 105 may actuate the brake system 130 based on data from the sensor 110 indicating an object according to an automatic braking algorithm. The computer 105 may actuate the user interface 140 based on data from the sensor 110 indicating an object to output a message to the operator indicating the presence of the object while executing forward collision detection or blind-spot detection. The computer 105 may operate the vehicle 100 autonomously, i.e., actuating the propulsion system 125, the brake system 130, and the steering system 135 based on data from the sensor 110, e.g., to navigate around an object detected by the sensor 110.

The computer 105 may be programmed to determine the vehicle pose 215 based on two relative positions 210 Sᵢ of the stationary object 205 and the calibration parameter Q, d. For example, the computer 105 may determine the vehicle rotation R_{i,j} and vehicle translation t_{i,j} by executing an optimization algorithm on a version of the geometric relationship described above. The geometric relationship may be represented as the following:

$${QS}_{j} = {R}_{i , j} {QS}_{i} + ( {R}_{i , j} d - d + {t}_{i , j} ) {1}^{T}$$

The optimization algorithm may use a dummy translation η_{i,j}:

$${η}_{i , j} = {R}_{i , j} d - d + {t}_{i , j}$$

The optimization algorithm may be set up as follows to determine the vehicle rotation R_{i,j} and the dummy translation η_{i,j} that minimizes a version of the geometric relationship that is arranged to equal zero:

$${min}_{{R}_{i , j} , {η}_{i , j}} {‖ {QS}_{j} - {R}_{i , j} {QS}_{i} - {η}_{i , j} {1}^{T} ‖}_{F}^{2}$$

The computer 105 may determine the vehicle translation t_{i,j} from the dummy translation η_{i,j}:

$${t}_{i , j} = {η}_{i , j} - {R}_{i , j} d + d$$

The vehicle rotation R_{i,j} and vehicle translation t_{i,j} may define the vehicle pose 215 from a known starting vehicle pose 215.

The computer 105 may be programmed to actuate a component of the vehicle 100 based on the vehicle pose 215. The component may include, e.g., the propulsion system 125, the brake system 130, the steering system 135, and/or the user interface 140. For example, the computer 105 may actuate the component in executing an ADAS. For example, the computer 105 may actuate the steering system 135 based on the distances to lane boundaries as part of a lane-centering feature, e.g., steering to prevent the vehicle 100 from traveling too close to the lane boundaries. The computer 105 may identify the lane boundaries using sensor data and/or map data. The computer 105 may determine the location of the vehicle 100 relative to the lane boundaries based on the vehicle relative pose 220. The computer 105 may, if the location of the vehicle 100 is within a distance threshold of one of the lane boundaries, instruct the steering system 135 to actuate to steer the vehicle 100 toward the center of the lane. For another example, the computer 105 may operate the vehicle 100 autonomously, i.e., actuating the propulsion system 125, the brake system 130, and the steering system 135 based on the vehicle relative pose 220, e.g., to navigate the vehicle 100 through an area.

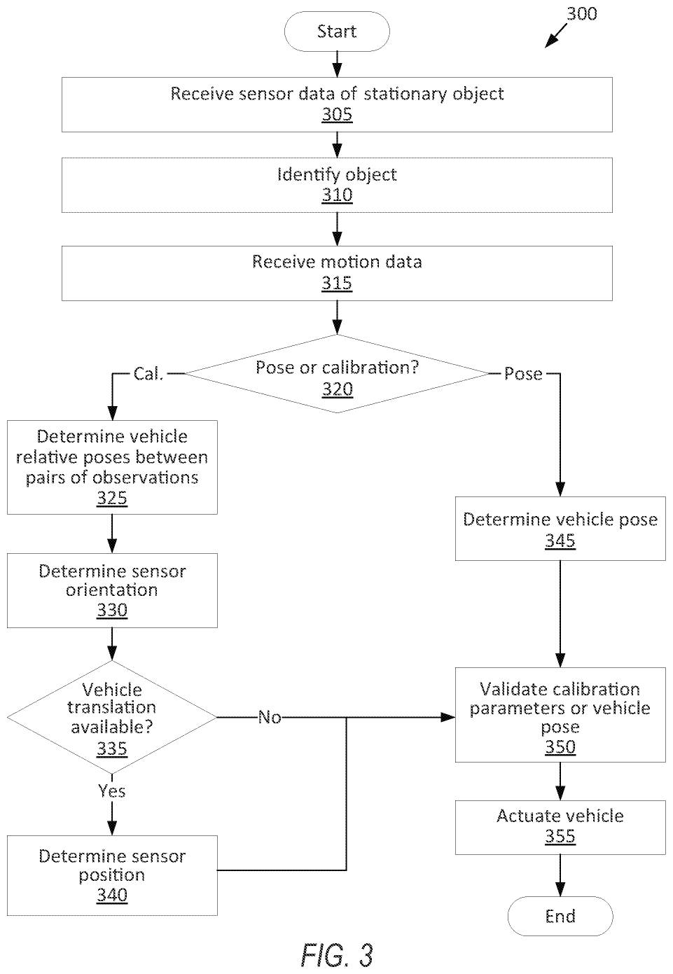

FIG. 3 is a flowchart illustrating an example process 300 for determining the calibration parameter or the vehicle pose 215 for the vehicle 100. The memory of the computer 105 stores executable instructions for performing the steps of the process 300 and/or programming can be implemented in structures such as mentioned above. As a general overview of the process 300, the computer 105 receives sensor data and motion data and determines the vehicle relative poses 220 between the pairs of the vehicle poses 215. Upon receiving an instruction to determine the calibration parameter, the computer 105 determines the sensor orientation and, if the vehicle translation is known, determines the sensor position. Upon receiving an instruction to determine the vehicle pose 215, the computer 105 determines the vehicle pose 215. The computer 105 validates whichever of the calibration parameter or vehicle pose 215 has just been determined and actuates the vehicle 100.

The process 300 begins in a block 305, in which the computer 105 receives sensor data indicating the stationary object 205, as described above.

Next, in a block 310, the computer 105 identifies the object 205 as a stationary object, as described above.

Next, in a block 315, the computer 105 receives the motion data from the motion sensors 120, as described above.

Next, in a decision block 320, the computer 105 determines whether to determine the calibration parameter or the vehicle relative pose 220, as described above. Upon receiving an instruction to determine the calibration parameter, the process 300 proceeds to a block 325. Upon receiving an instruction to determine the vehicle relative pose 220, the process 300 proceeds to a block 345.

In the block 325, the computer 105 determines the vehicle relative poses 220 based on the motion data, as described above.

Next, in a block 330, the computer 105 determines the sensor orientation based on the relative positions 210 of the stationary object 205 and the vehicle rotation, as described above.

Next, in a decision block 335, the computer 105 determines whether the vehicle translation of the vehicle relative pose 220 is available, i.e., known, i.e., stored in the computer 105. If the vehicle translation is available, the process 300 proceeds to a block 340. Otherwise, the process 300 proceeds to a block 350.

In the block 340, the computer 105 determines the sensor position based on the vehicle rotation and the vehicle translation, as described above. After the block 340, the process 300 proceeds to the block 350.

In the block 345, the computer 105 determines the vehicle relative pose 220 based on two relative positions 210 of the stationary object 205 and the calibration parameter, as described above. After the block 345, the process 300 proceeds to the block 350.

In the block 350, the computer 105 validates whichever of the calibration parameter or vehicle relative pose 220 has just been determined. For the vehicle relative pose 220, the computer 105 may determine the vehicle relative pose 220 using a different methodology, e.g., motion data from the motion sensors 120. For the calibration parameter, the computer 105 may determine the vehicle relative pose 220 based on the calibration parameter as in the block 345 and determine the vehicle relative pose 220 using a different methodology, e.g., motion data from the motion sensors 120.

Next, in a block 355, the computer 105 actuates a component of the vehicle 100 based on the one of the calibration parameter or the vehicle relative pose 220 that has just been determined, as described above. The component may include, e.g., the propulsion system 125, the brake system 130, the steering system 135, and/or the user interface 140. After the block 355, the process 300 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first,” “second,” etc. are used throughout this document as identifiers and are not intended to signify importance, order, or quantity. Use of “in response to” and “upon determining” indicates a causal relationship, not merely a temporal relationship. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
receive first sensor data from a sensor of a vehicle indicating a first relative position of a stationary object, the first relative position detected while the vehicle is in a first vehicle pose;
receive second sensor data from the sensor indicating a second relative position of the stationary object, the second relative position detected while the vehicle is in a second vehicle pose having a different orientation than the first vehicle pose; and
determine one of a calibration parameter or a vehicle relative pose based on the first relative position, the second relative position, and the other of the calibration parameter or the vehicle relative pose,
the calibration parameter defining a sensor pose of the sensor relative to the vehicle; and
the vehicle relative pose defining a transformation of the vehicle from the first vehicle pose to the second vehicle pose.

2. The computer of claim 1, wherein the instructions further include instructions to actuate a component of the vehicle based on the one of the calibration parameter or the vehicle relative pose.

3. The computer of claim 1, wherein the instructions further include instructions to determine the calibration parameter based on the first relative position of the stationary object, the second relative position of the stationary object, and the vehicle relative pose.

4. The computer of claim 3, wherein the instructions further include instructions to determine the vehicle relative pose based on motion data of the vehicle.

5. The computer of claim 4, wherein the vehicle relative pose includes a vehicle translation and a vehicle rotation, and the motion data defines the vehicle translation and the vehicle rotation.

6. The computer of claim 3, wherein the instructions further include instructions to:
receive sensor data indicating a plurality of relative positions of the stationary object, the relative positions including the first relative position and the second relative position, the relative positions detected while the vehicle is in a plurality of vehicle poses including the first vehicle pose and the second vehicle pose; and
determine a plurality of vehicle relative poses between pairs of the vehicle poses of the vehicle, the vehicle relative poses including the vehicle relative pose.

7. The computer of claim 6, wherein the instructions further include instructions to determine the calibration parameter based on the relative positions of the stationary object and the vehicle relative poses.

8. The computer of claim 6, wherein the pairs of the vehicle poses of the vehicle includes at least one pair in which the vehicle poses are nonconsecutive.

9. The computer of claim 6, wherein at least one of the vehicle poses of the vehicle is in at least two of the pairs.

10. The computer of claim 6, wherein at least one of the vehicle poses of the vehicle is in at least three of the pairs.

11. The computer of claim 6, wherein the plurality of the vehicle poses of the vehicle is nonlinear.

12. The computer of claim 3, wherein the calibration parameter includes a sensor orientation of the sensor relative to the vehicle.

13. The computer of claim 12, wherein the vehicle relative pose includes a vehicle rotation, and the instructions further include instructions to determine the sensor orientation based on the first relative position of the stationary object, the second relative position of the stationary object, and the vehicle rotation.

14. The computer of claim 13, wherein the vehicle relative pose includes a vehicle translation, and the instructions to determine the sensor orientation include instructions to determine the sensor orientation without the vehicle translation.

15. The computer of claim 13, wherein the calibration parameter includes a sensor position of the sensor relative to the vehicle, the vehicle relative pose includes a vehicle translation, and the instructions further include instructions to determine the sensor position based on the vehicle rotation and the vehicle translation.

16. The computer of claim 1, wherein the instructions further include instructions to determine the vehicle relative pose based on the first relative position of the stationary object, the second relative position of the stationary object, and the calibration parameter.

17. The computer of claim 16, wherein the calibration parameter includes a sensor orientation of the sensor relative to the vehicle and a sensor position relative to the vehicle.

18. The computer of claim 1, wherein the vehicle relative pose includes a vehicle translation and a vehicle rotation.

19. The computer of claim 1, wherein the sensor is one of a radar, a lidar, or a camera.

20. A method comprising:
receiving first sensor data from a sensor of a vehicle indicating a first relative position of a stationary object, the first relative position detected while the vehicle is in a first vehicle pose;
receiving second sensor data from the sensor indicating a second relative position of the stationary object, the second relative position detected while the vehicle is in a second vehicle pose having a different orientation than the first vehicle pose; and
determining one of a calibration parameter or a vehicle relative pose based on the first relative position, the second relative position, and the other of the calibration parameter or the vehicle relative pose,
the calibration parameter defining a sensor pose of the sensor relative to the vehicle; and
the vehicle relative pose defining a transformation of the vehicle from the first vehicle pose to the second vehicle pose.
